(19) United States
(12) Patent Application Publication
(10) Pub. No.: US 2009/0068884 A1
(43) Pub. Date: Mar. 12, 2009

(54) Connecting structure of printed circuit board for coaxial cable

(75) Inventors: Han-Ho Kim, Seoul (KR); Se-Ok Lee, Seoul (KR); Jong-Eun Ahn, Suwon-si (KR)

Correspondence Address: STAAS & HALSEY LLP, SUITE 700, 1201 NEW YORK AVENUE, N.W., WASHINGTON, DC, 20005, US

(73) Assignee: Yoowon Com-Tech Co., Ltd., Eumseong-gun (KR)

(21) Appl. No.: 11/919,873

(22) PCT Filed: Nov. 3, 2005
(86) PCT No.: PCT/KR2005/003683

§ 371 Date: Nov. 5, 2007

(30) Foreign Application Priority Data
Jun. 16, 2005 (KR) 10-2005-0052075

(51) Int. Cl. H01R 9/05

(52) U.S. Cl. 439/578

(57) ABSTRACT

The present invention relates to a coaxial cable structure for connecting to a printed circuit board including: a coaxial cable part having a plurality of signal lines, an inner insulator, a shield wire covered along the outer periphery of the inner insulator, and an outer insulator covered along the outer periphery of the shield wire; a pattern part formed on one surface of the printed circuit board, and serving as a conductor adapted to abut against the signal lines exposed to the outside of the coaxial cable part, the pattern part having the corresponding the plurality of signal lines; number of signal patterns to and a ground pattern adapted and a soldering part adapted to directly solder each the coaxial cable part portions thereof to the pattern part of signal line and exposed to the each shield wire of outside at the end the printed circuit board.

### CROSS-REFERENCE TO RELATED APPLICATIONS

This application claims the benefit under 35 U.S.C. Section 371, of PCT International Application Number PCT/KR2005/003683, filed Nov. 3, 2005 and Korean Application No. 10-2005-0052075, filed Jun. 16, 2005 in Republic of Korea, the contents of which are incorporated herein by reference.

### BACKGROUND

1. Field

One or more embodiment of the present invention relates to a coaxial cable structure for connecting to a printed circuit board, which is adapted to connect spaced-apart modules to each other for transmitting data between the modules, and more particularly, to a coaxial cable structure for connecting to a printed circuit board wherein spaced-apart modules are connected to each other by means of substantially flexible coaxial cables such that even though the module is rotated to a given angle, no excessive pressure is applied to the connected portion between the two modules, and the printed circuit board provided on each module that receives and transmits data through the coaxial cables has a pattern part directly formed thereon, such that as the signal lines of the coaxial cables are directly soldered to the pattern part, the coaxial cables having excellent flexibility in response to the rotation of the module can be used as a data transmitting means between the spaced apart modules, without having any separate connector thereon.

2. Description of the Related Art

Generally, spaced-apart modules each having a printed circuit board provided thereon are connected to transmit the signal generated from one module to the other module, and a flexible printed circuit board (FPCB) is usually used as a data transmission device on which a body having a key input means or a radio receiving means and a liquid crystal display window for displaying the input results like a mobile communication terminal are connected to each other.

Recently, with the change in the functions of a mobile 5 communication terminal like a camera phone or a satellite digital multimedia broadcasting (DMB) phone from simple telephone functions or text-providing functions of providing text or fixed picture files by using wireless internet to a function of providing moving pictures like high qualities of photos, television programs, or image retrieval, the liquid crystal display window should be rotated at a variety of angles having a range between 90° and 360°. However, the flexible printed circuit board is designed to conduct one-way rotation, and thus, it does not allow the free rotation to the liquid crystal display window.

So as to provide the rotation at given angles to the existing flexible printed circuit board having the one-way bending feature, recently, the flexible printed circuit board is formed of a plurality of thin plates having two or three folding portions thereon, such that the flexible printed circuit board and the signal lines embedded therein are not damaged during the rotation.

In case of forming the three folding portions on the flexible printed circuit board, however, the flexible printed circuit board can conduct its rotation through three one-way bending operations, such that whenever the bending occurs repeatedly on the folding portions, given forces are continuously applied to the predetermined portions on the flexible printed circuit board, thereby making the predetermined portions easily damaged.

Further, when the plurality of thin plates that are formed on the flexible printed circuit board are bent at almost same timings, there occur problems that the plurality of thin plates have somewhat different bending timings and unnecessary noises are generated due to the tough feature of the flexible printed circuit board.

In case of connecting spaced-apart modules to each other by means of the flexible printed circuit board, further, the signal lines provided on the flexible printed circuit board are all disposed on one printed circuit board, thereby making the patterns of the printed circuit board directly exposed to the outside, such that there occurs a problem that no shielding efficiencies are expected to the noises occurring on the signal lines and the electromagnetic interference (EMI).

So as to solve these problems, recently, there is presented a new device for connecting spaced-apart modules by using a plurality of independent coaxial cables, but in the prior art embodiment, a connector for connecting one end of each coaxial cable and the printed circuit board is additionally adopted; such that there occur some problems that existing manufacturing processes should be completely changed, the manufacturing processes become complicated, and the manufacturing costs become high.

### SUMMARY

Additional aspects and/or advantages will be set forth in part in the description which follows and, in part, will be apparent from the description, or may be learned by practice of the invention.

Accordingly, it is an embodiment to provide a coaxial cable structure for connecting to a printed circuit board, which is adapted to connect spaced-apart modules to each other by means of a plurality of thin coaxial cables having free motions in shapes, thereby having no influence on the external forces applied to various directions as well as one-way bending, without having any damages during the repeated rotations of one module.

Another embodiment is to provide a coaxial cable structure for connecting to a printed circuit board, which is adapted to connect spaced-apart modules to each other by means of a plurality of coaxial cables having excellent flexibility and very low noises during the free motions in shapes, each of the plurality of coaxial cables having an inner insulator and an outer insulator, thereby suppressing the generation of noises unnecessarily caused upon the bending and rotation of one module.

Still another embodiment is to provide a coaxial cable structure for connecting to a printed circuit board wherein each of the signal lines for transmitting data in a plurality of coaxial cables is encompassed with an inner insulator and encompassed again with a shield wire for shielding electromagnetic waves, thereby completely shielding the noises on the signal lines or the electromagnetic interference generated by adjacent signal lines.

Yet another embodiment is to provide a coaxial cable structure for connecting to a printed circuit board wherein the signal line of each of a plurality of coaxial cables is exposed to the outside at both ends thereof and is directly soldered to a pattern part formed on the printed circuit board, without having any separate connector, thereby making it possible to partially vary the existing manufacturing process as no additional process of making the connector only for use in the coaxial cable is needed.

According to an aspect of the embodiment, the coaxial cable structure for connecting to a printed circuit board has an effect in that spaced-apart modules are connected to each other by means of a plurality of thin coaxial cables having free motions in shapes, thereby having no influence on the external forces applied to various directions, without having any damages during the repeated rotation of the printed circuit board.

According to an aspect of the embodiment, the coaxial cable structure for connecting to a printed circuit board connecting structure has another effect in that spaced-apart modules are connected to each other by means of a plurality of coaxial cables having excellent flexibility and very low noises during the free motions in shapes, each of the plurality of coaxial cables having an inner insulator and an outer insulator, thereby suppressing the generation of noises unnecessarily caused upon the rotation of one module.

According to an aspect of the embodiment, the coaxial cable structure for connecting to a printed circuit board has still another effect in that each of a plurality of signal lines is encompassed with an inner insulator and encompassed again with a shield wire, thereby completely shielding the noises on the signal lines or the electromagnetic interference generated by adjacent signal lines.

According to an aspect of the embodiment, the coaxial cable structure for connecting to a printed circuit board has still yet another effect in that the signal lines of each of a plurality of coaxial cables is exposed to the outside at both ends thereof and is directly soldered to a pattern part formed on the printed circuit board, without having any separate connector for the spaced-apart modules, thereby making it possible to partially vary the existing manufacturing process and further resulting in the reduction of the producing processes and costs.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a plane view showing an entire coaxial cable structure for connecting to a printed circuit board according to the present invention;

FIG. 2 is an enlarged plane view showing a partial coaxial cable structure for connecting to a printed circuit board according to the present invention;

FIG. 3 is a sectional view taken along the line A-A of FIG. 2;

FIG. 4 is a sectional view taken along the line B-B of FIG. 2;

FIG. 5 is a perspective view showing a coaxial cable part of the coaxial cable structure according to the present invention;

FIG. 6 is a plane view showing a pattern part of the printed circuit board in the coaxial cable structure according to the present invention; and

FIG. 7 is a perspective view showing the coaxial cable part having a position fixing member formed thereon in the coaxial cable structure according to the present invention.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

According to an aspect of the embodiment, there is provided a coaxial cable structure for connecting to a printed circuit board, the coaxial cable structure including: a coaxial cable part having a plurality of coaxial cables adapted for transmitting data to the printed circuit board, each of the plurality of coaxial cables having a signal line for transmitting data to the printed circuit board, an inner insulator covered along the outer periphery of each signal line, a shield wire covered along the outer periphery of the inner insulator for shielding the plurality of signal lines from one another, and an outer insulator covered along the outer periphery of the shield wire to form an outer layer of each signal line; a pattern part formed on one surface of the printed circuit board, and serving as a conductor adapted to abut against the signal lines exposed to the outside of the coaxial cable part for receiving data from the coaxial cable part, the pattern part having the corresponding number of signal patterns to the plurality of signal lines and a ground pattern adapted for providing ground contacts; and a soldering part adapted to directly solder each signal line and each shield wire of the coaxial cable part exposed to the outside at the end portions thereof to the pattern part of the printed circuit board.

In an embodiment, the soldering part is adapted to solder each of the signal lines to the corresponding signal pattern and to each of the shield wires to the ground pattern, and in this case, the soldering wire is in a bar-like configuration such that the shield wires are integrally soldered to the ground pattern.

In another embodiment, the coaxial cable part has a bar-like position fixing member formed on both ends thereof, for securely fixing the plurality of coaxial cables.

Hereinafter, an explanation on a coaxial cable structure for connecting to a printed circuit board according to a preferred embodiment of the present invention will be given.

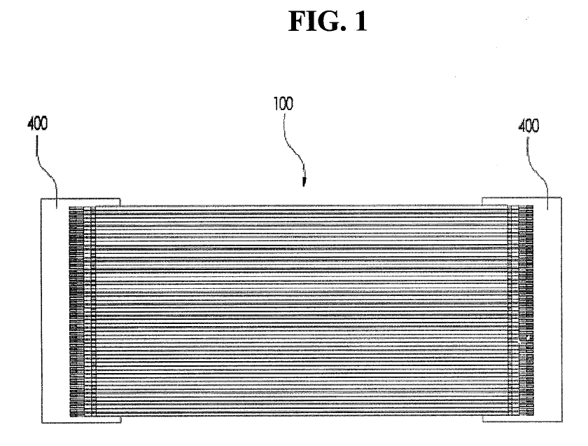

As shown in FIG. 1, a coaxial cable structure for connecting to a printed circuit board according to a preferred embodiment of the present invention includes: a coaxial cable part 100 adapted to transmit data to the printed circuit board 400; a pattern part 200 formed as a conductor on one surface of the printed circuit board for receiving the data transmitted from the coaxial cable part 100; and a soldering part 300 adapted to directly solder each signal line 110 of the coaxial cable part 100 to the pattern part 200 of the printed circuit board 400.

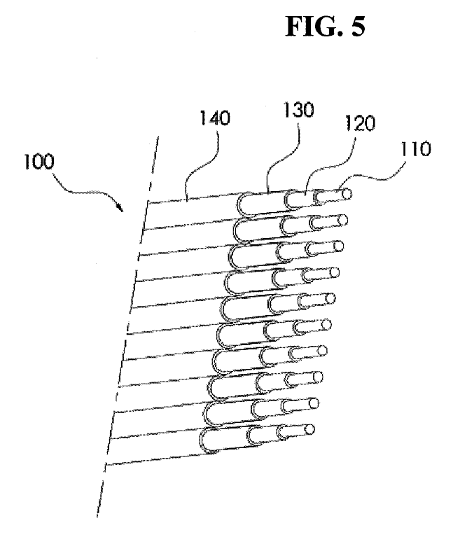

The coaxial cable part 100 is, as shown in FIG. 5, comprised of a plurality of coaxial cables each having a signal line 110 formed as a conductor for receiving and transmitting data from/to the printed circuit board, an inner insulator 120 adapted to encompass the outer periphery of the signal line 110 for preventing the loss of data transmitted through the signal line 110, a shield wire 130 adapted to encompass the outer periphery of the inner insulator 120 for blocking the electromagnetic interference caused by the adjacent signal lines 110 to make the adjacent signal lines 110 shielded from one another, and an outer insulator 140 adapted to encompass the outer periphery of the shield wire 130 to form an outer layer of each signal line.

At this time, the coaxial cable part 100 may vary the thickness thereof and the number of coaxial cables included therein in accordance with the kinds of data transmission devices and the data transmission quantities thereof, and in case where the coaxial cable part 100 is applied to mobile communication terminals, it is desirably reduced in thickness to a micro coaxial cable, thereby achieving the slimming effects of the mobile communication terminals.

Further, the outer insulators 140, the shield wires 130, and the inner insulators 120 formed on the both ends of the coaxial cable part 100 are removed by means of laser processing, for conducting the soldering process to the pattern part 200 as will be discussed below.

That is, the outer insulators 140, the shield wires 130, and the inner insulators 120 formed on the both ends of the coaxial cable part 100 are removed sequentially to have steps to a given length thereon in such a manner as to be exposed to the outside, and thus, each of the both ends of the coaxial cable part 100 comes into contact with the pattern part 200 thus to transmit data to the printed circuit board 400.

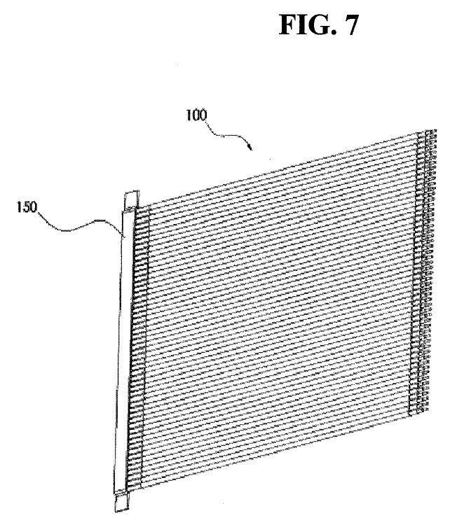

After that, as shown in FIG. 7, a position fixing part 150 is further mounted on the both end portions of the outer insulator 140 of the coaxial cable part 100 for securely fixing the plurality of coaxial cables to their positions such that the coaxial cables are easily soldered to the pattern part 200, without any changes in their positions.

At this time, the position fixing part 150 is in a bar-like configuration having given toughness in such a manner as to surround the upper and lower portions of the plurality of coaxial cables, such that even upon application of external forces, the plurality of coaxial cables are rigidly disposed at their positions.

At this time, the plurality of coaxial cables can be arranged in a line by means of the position fixing part 150, and of course, they may be bound all together through separate binding means.

At this time, since the coaxial cable part 100 is made of a flexible material that may be bent in every direction by the application of external forces, the data that is received wirelessly through input means like a keypad or an antenna from the mobile communication terminal and is subjected to given processing through the control unit of the mobile communication terminal is displayed on a liquid crystal display window that is disposed at a given position by means of the rotation of a hinge part of the mobile communication terminal.

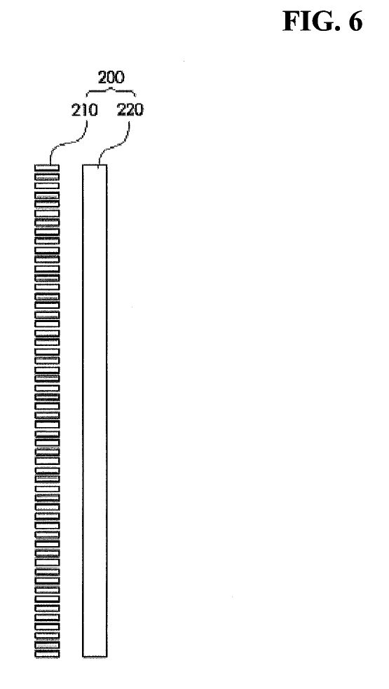

The pattern part 200 is, as shown in FIG. 6, formed on one surface of the printed circuit board 400, and serves as a conductor that is adapted to abut against the signal lines 110 exposed to the outside of the coaxial cable part 100, for receiving data from the coaxial cable part 100 and transmitting the received data to each module.

At this time, the pattern part 200 includes: the corresponding number of signal patterns 210 to the plurality of signal lines 110 adapted to abut against the signal lines 110 of the coaxial cable part 100 for receiving data from the coaxial cable part 100; and a ground pattern 220 adapted to abut against the shield wires 130 of the coaxial cable part 100.

The signal patterns 210 are extended to a given length such that the data received from the signal lines 110 can be transmitted to the module of the printed circuit board 400, and the ground pattern 220, which is spaced apart from the signal patterns 210, desirably has a bar-like shape formed in a direction of connecting the coaxial cables for soldering to the shield wires 130.

Also, in case where slim devices like the mobile communication terminal are needed, desirably, the micro coaxial cables are used as the coaxial cables and the printed circuit board 400 on which the pattern part 200 is formed has a substantially thin thickness.

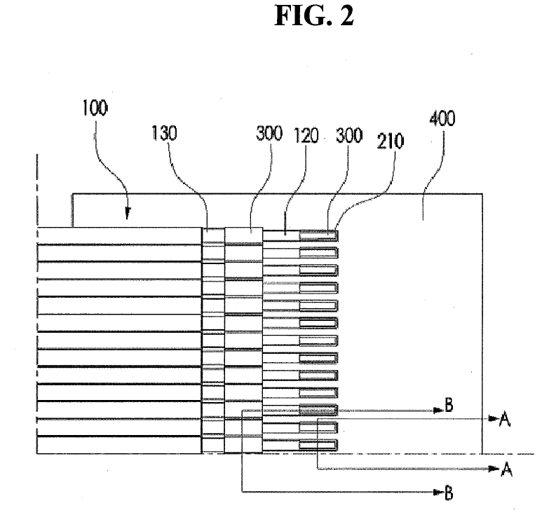

The soldering part 300 is, as shown in FIG. 2, adapted to directly fix the coaxial cable part 100 on the pattern part 200 of the printed circuit board 400, for transmitting the data received from the coaxial cable part 100 to the printed circuit board 400, without having a separate connector only for use in the coaxial cables.

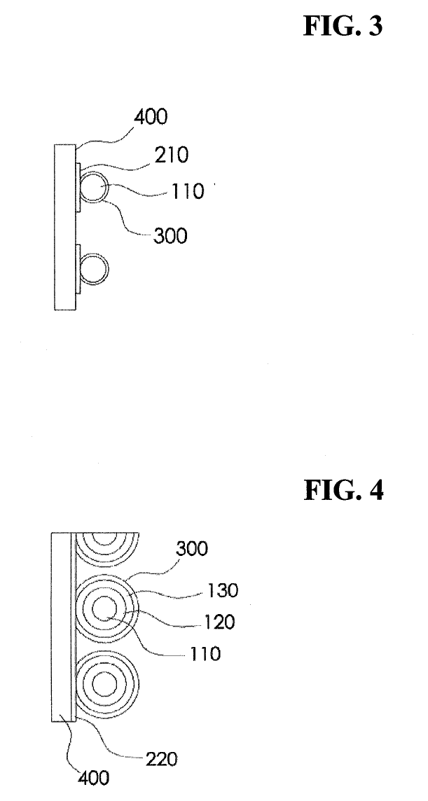

At this time, as shown in FIGS. 3 and 4, the signal lines 110, which are processed on the both ends of the coaxial cable part 100 in such a manner as to be exposed to the outside, are appropriately disposed on the signal patterns 210 of the pattern part 200, and in this manner, the shield wires 130 are disposed on the ground pattern 220, such that the signal lines 110 and the shield wires 130 are soldered to the pattern part 200 by means of a soldering device like a pulse heater.

Next, an explanation on the operation of the coaxial cable structure for connecting to the printed circuit board according to the preferred embodiment of the present invention will be discussed below.

At this time, the coaxial cable structure according to the present invention is applied to the mobile communication terminal having rotating means attached to a liquid crystal display.

First, the coaxial cables are disposed between a body part and a liquid crystal display as two modules of the mobile communication terminal, and then, the coaxial cable part 100 having the signal lines 110, the inner insulators 120, and the shield wires 130 removed at both ends thereof in such a manner as to have steps by a given length and be exposed to the outside is disposed between the printed circuit board 400 of the body part of the mobile communication terminal and the printed circuit board 400 of the liquid crystal display.

At this time, the signal patterns 210 are formed correspondingly to the signal lines 110 of the coaxial cable part 100 on the printed circuit board 400 of each module, and the ground pattern 220 is formed according to the width of the coaxial cable part 100 (that is, the width relative to the number of coaxial cables), such that the signal lines 110 and the shield wires 130 come into contact with the signal patterns 210 and the ground pattern 220 of the pattern part 200.

After that, the signal lines 110 are soldered to the signal patterns 210 and the shield wires 130 are soldered to the ground pattern 220 by means of a soldering device like a pulse heater.

Thus, the coaxial cable part 100 can be connected to the body part and the liquid crystal display of the mobile communication terminal, without having any connector only for use in the coaxial cables.

If the liquid crystal display is rotated after the coaxial cable part 100 is fixedly mounted to the pattern part 200 on each printed circuit board 400 by means of the soldering part 300, the coaxial cable part 100 having the plurality of coaxial cables formed therein are rotated to given angles.

At this time, the coaxial cable part 100 is relatively free in motions of the shape thereof, and thus, it is not easily damaged even during the repeated uses.

Although a few embodiments have been shown and described, it would be appreciated by those skilled in the art that changes may be made in these embodiments without departing from the principles and spirit of the invention, the scope of which is defined in the claims and their equivalents.

1. A coaxial cable structure for connecting to a printed circuit board, the coaxial cable structure comprising:
a coaxial cable part having a plurality of coaxial cables adapted for transmitting data to the printed circuit board, each of the plurality of coaxial cables having a signal line for transmitting data to the printed circuit board, an inner insulator covered along the outer periphery of each signal line, a shield wire covered along the outer periphery of the inner insulator for shielding the plurality of signal lines from one another, and an outer insulator covered along the outer periphery of the shield wire to form an outer layer of each signal line;
a pattern part formed on one surface of the printed circuit board, and serving as a conductor adapted to abut against the signal lines exposed to the outside of the coaxial cable part for receiving data from the coaxial cable part, the pattern part having the corresponding number of signal patterns to the plurality of signal lines and a ground pattern adapted for providing ground contacts; and
a soldering part adapted to directly solder each signal line and each shield wire of the coaxial cable part exposed to the outside at the end portions thereof to the pattern part of the printed circuit board.

2. The coaxial cable structure according to claim 1, wherein the soldering part is adapted to solder each of the signal lines to the corresponding signal pattern and to each of the shield wires to the ground pattern, and the soldering wire is in a bar-like configuration such that the shield wires are integrally soldered to the ground pattern.

3. The coaxial cable structure according to claim 1, wherein the outer insulators, the shield wires, and the inner insulators formed on the both ends of the coaxial cable part are removed sequentially by a given length thereon to have steps to the given length thereon, based upon the spaced distance between the signal patterns and the ground pattern of the printed circuit board, such that the signal lines, the inner insulators, and the shield wires of the coaxial cable part are exposed to the outside on the both ends of the coaxial cable part.

4. The coaxial cable structure according to claim 1, wherein the coaxial cable part further has a bar-like position fixing member formed on both ends thereof, for securely fixing the plurality of coaxial cables to one another.

5. The coaxial cable structure according to claim 3, wherein the coaxial cable part further has a bar-like position fixing member formed on both ends thereof, for securely fixing the plurality of coaxial cables to one another.
